(19) United States
(12) Patent Application Publication
(10) Pub. No.: US 2009/0207589 A1
(43) Pub. Date: Aug. 20, 2009

(54) READING STAND

(76) Inventor: David Smith, San Diego, CA (US)

Correspondence Address: WESLEY B. AMES, 7031 LOS VIENTOS SERENOS, ESCONDIDO, CA, 92029, US

(21) Appl. No.: 12/032,757

(22) Filed: Feb. 18, 2008

(51) Int. Cl. F21V 33/00; A47B 97/04

(52) U.S. Cl. 362/98; 248/452

(57) ABSTRACT

A reading stand is described which includes a stabilizing base, a column extending upward from the base, and an arm projecting laterally from the column. Mounted at or near the end of the arm is a clamp which is used to hold reading material and/or a reading material support. Reading material placed in the claim is fully or at least substantially below the level of the arm, thereby providing greater clearance between a reader's body and the arm.

### RELATED APPLICATIONS

NOT APPLICABLE.

### FIELD OF THE INVENTION

The present invention relates to devices for holding reading materials.

### BACKGROUND OF THE INVENTION

The following discussion is provided solely to assist the understanding of the reader, and does not constitute an admission that any of the information discussed or references cited constitute prior art to the present invention.

A variety of different reading stands have been described, many of which are designed for resting on or straddling a person's lap. Other described reading stands or book holding devices include the following.

Simington et al. U.S. Pat. No. 5,615,856, issued Apr. 1, 1997, describes a book holding device which includes oppositely disposed book-support plates connected by a member which is attachable to a connector bracket with universal positioning provided by a stand which is foldable or optionally mobile.

Gordon, U.S. Pat. No. 6,027,092, issued Feb. 22, 2000, describes a book stand which includes a based adapted to fit under a person's leg, a first arm pivotally attached to the base, a second art telescopically attached to the first arm, and a book rack pivotally attached to the second arm.

Hsia, U.S. Pat. No. 6,672,556, issued Jan. 6, 2004, describes a reading device having an upright stand, a beam hinged to the stand, a spring linking the stand and the beam, and a carrier for an object.

Brought, U.S. Pat. No. D499,899, issued Dec. 21, 2004, describes a design for a book reading stand.

### SUMMARY OF THE INVENTION

The present invention concerns a reading stand which holds a book magazine, or other reading material in an elevated position. Such a stand is particularly advantageous for a person to read while in a prone or generally reclining position, but can also be used in other circumstances.

Thus, a first aspect of the invention concerns a reading stand which includes a stabilized upright stand column, a laterally extending arm attached to said column, and a reading material clamp mounted substantially distally on the arm.

In particular embodiments, the column is mounted in a stabilizing base, e.g., a weighted base, a wheeled base, or a weighted and wheeled base; the clamp comprises two clamps in in-line orientation; the clamp comprises two clamp surfaces in in-line orientation.

In certain embodiments, the arm is pivotably attached to the stand column such that the height of the distal end of said arm can be adjusted; the length of the arm is adjustable; the height of the stand column is adjustable; the inclination of reading material clamped in the clamp is adjustable; the arm is rotatable about the column axis.

Also in certain embodiments, the reading stand also includes a reading material support surface, which may be held in the clamp, or the clamp may be mounted on the support surface, e.g., with the support surface mounted on the arm; the reading material support surface is mounted substantially below the arm.

In most embodiments, the reading material clamp is oriented such that reading material clamped in it extends below the clamp; reading material held in the clamp is at least predominantly below the arm.

The reading stand may also include a reading light oriented to provide illumination for reading material held on the reading stand.

In further embodiments, the reading stand includes a holder extension which extends from at or near the end of the arm distal from the stand, such extension having the clamp mounted thereon, or including a reading material support; the reading stand includes at least one page retainer directly or indirectly linked with the clamp or the reading material support.

Additional embodiments will be apparent from the Detailed Description and from the claims.

### BRIEF DESCRIPTION OF THE DRAWINGS

FIG. 1 shows a schematic view of an exemplary reading stand.

FIG. 2 shows a view of an exemplary arm pivot.

FIG. 3 shows an exemplary wheeled base.

FIG. 4 shows an exemplary angle adjustable reading material support with clamps mounted to the support.

FIG. 5 shows an exemplary reading material support where the support is mounted to a clamp.

### DETAILED DESCRIPTION OF THE PREFERRED EMBODIMENTS

The present invention provides and advantageous reading stand, which is particularly well adapted for use by a person in a reclining or sitting position. In contrast to many designs, the present design provides good clearance of the frame of the stand over a person's body.

In general, the reading stand has an upright support column attached to a base, with an arm extending laterally from the column. Mounted at or near the end of the arm is a clamp for an item of reading material such as a book. In a simple configuration, the clamp is the only component contacting the book or other item, and the book extends below the arm. In this way, there is substantial clearance between the arm and the reader's body. If desired, the stand may include a reading material support surface, e.g., with both the clamp and the support surface attached to the arm, with the reading support surface clamped in the clamp which is attached to the art, or with the reading support surface attached to the arm and the clamp mounted on the reading support surface. In any such configuration, the clamp and/or reading support surface may be attached such that the angle of reading material may be varied (e.g., in a forward and backward direction). Such angle adjustment may, for example, be provided using clamping or locking hinge(s), hinges(s) having spring detents, or clamp type connections (e.g., to the arm).

It can be advantageous in some cases to include a column pivot (especially in embodiments which do not include wheels. Such a pivot can, for example, allow a reader to rotate the arm generally about the column axis. This can, for example, be useful to allow the reader to swing the arm (and reading material if present) out of the way to make standing up more convenient. The pivot may be constructed and located in any of a number of different ways. For example, the pivot may be constructed as part of the column, at the base of the column, or at the junction of the column and the arm. Alternatively, the pivot may be in the arm. If a pivot is present allowing vertical adjustment of the arm, the pivot allowing rotation generally about the column axis may be the same (i.e., a single pivot construct providing two axis pivoting), or may be a separate pivot construct.

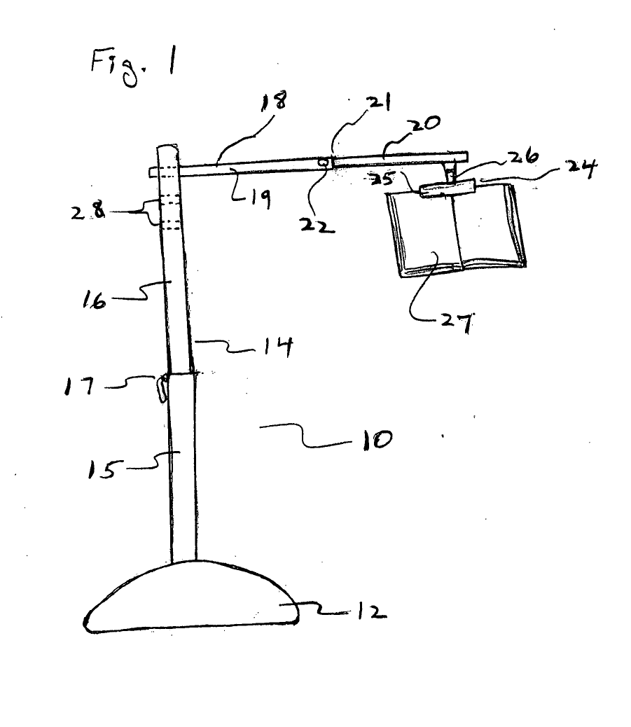

Some exemplary embodiments are illustrated in the drawings. Referring to FIG. 1, an example of a reading stand 10 is shown. The stand includes a base 12, which may be a weighted base, e.g., fillable with sand, water, or other such material, or having a relatively heavy construction. Extending upwardly from the base is a support column 14. In many cases, the support column will be essentially vertical when the stand is resting on the base, but this is not necessary. For example curving or somewhat angled columns may also be used so long as the configuration is such that the stand as a whole is sufficiently stable. In this embodiment, the column is an adjustable height stand, in this case a telescoping column. The illustrated column includes telescoping lower column piece 15 and upper column piece 16, where the position of the upper piece within the lower piece can be locked with lock 17 (in this case a cam lock although other types of locks, such as clamp screws, spring locks, and lock pins, may be used).

The stand also includes lateral extending arm 18, which is length adjustable. In this example, the length of arm 18 can be adjusted similarly to the stand using telescoping arm pieces, in this case proximal arm piece 19 and distal arm piece 20, which slide together at telescoping joing 21. The relative position of the arm pieces can be fixed using locks similar to those mentioned for the stand; in this case a thumbscrew lock 22 is illustrated. The height of the arm in this embodiment is further adjustable by varying the position of the arm on the column. In the embodiment illustrated, such adjustment is provided using holes 28 through the column into which the proximal end of the arm fits. The arm may be free-floating, or may be fixed in place, e.g., using springs retainers (with or without detents, spring locks, or the like), lock screws or pins, or clamps).

Near the distal end of the arm is mounted a reading material clamp or spring clip 24, with clip face 25 and clamp lever 26. A piece of reading material 27 (e.g., a book or magazine) is clamped in place and then can be readily read without hand support. The clamp may be mounted directly below the arm so that the reading material hangs essentially vertically, or may be mounted such that the reading material is at an angle away from the vertical. In general, the clamp is mounted such that all or at least most of the reading material is below the arm when the reading material is in place in the clamp. The single clamp illustrated in FIG. 1 may be replaced with other clamp configurations, e.g., two clamps (e.g., one for each side of an opened book or magazine) or a clamp with two separated segments (e.g., with one segment for each side of an opened book or magazine).

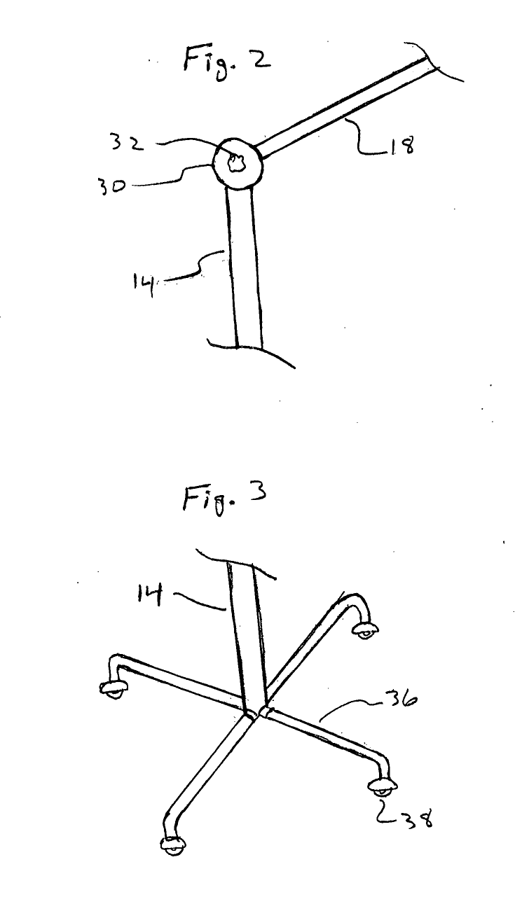

As illustrated in FIG. 2, the elevation of the distal end of the arm may also be adjusted using other mechanisms, such as a pivoting connection, e.g., the one shown as pivoting connection 30. In this embodiment, the pivot has a clamp plate which is tightened against a mixed plate using a handscrew 32. Other types of pivoting and/or clamping mechanisms may also be used. Likewise, the illustrated embodiment has the pivot located on the column (in this case at the top of the column). Other particular pivot locations may also be used. For example, the pivot may be located on the arm, e.g., near the proximal end of the arm. Also, instead of or in addition to a clamping mechanism to hold the arm at a desired inclination, friction and/or spring-compensated mechanisms may be used. For stands which incorporate a pivot for arm angle adjustment, it can be advantageous to provide a corresponding pivot at or near the attachment for the reading material clamp or other mount for a reading material clamp or reading material support in order to allow reading material to be in an appropriate orientation for reading.

FIG. 3 shows an alternative base to the one shown in FIG. 1, one which is wheeled allowing convenient positioning of the stand. Of course, other types of bases can be wheeled, including ones like or similar to that shown in FIG. 1. The simple wheeled base shown in FIG. 3 includes four base arms 36 with caster type wheels at the distal termini of the arms. As shown, the column 14 rises from the central junction of the arms.

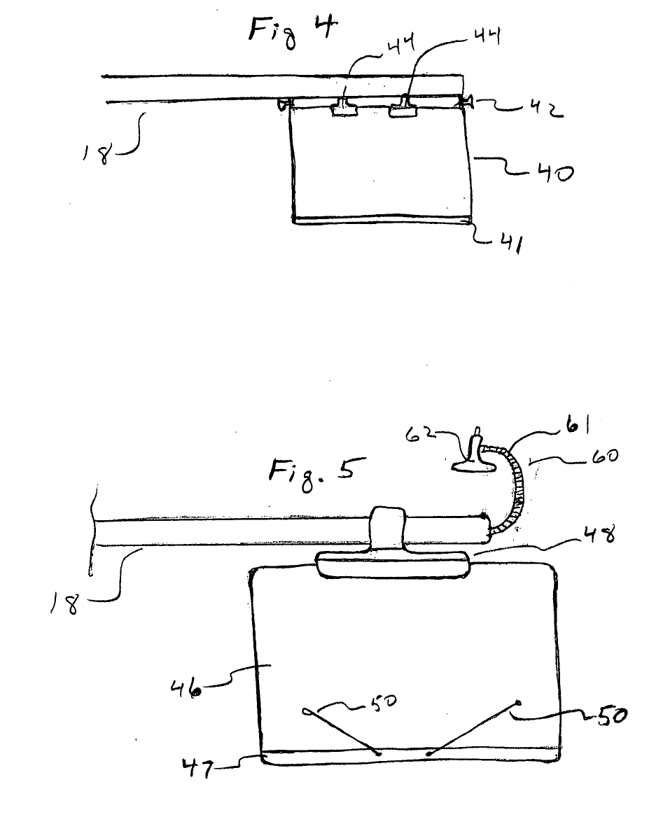

FIG. 4 and FIG. 5 show additional options for restraining the reading material, in these cases including a reading material support. In FIG. 4, the reading material support 40 is mounted to arm 18 via adjustable hinges 42 which include thumbscrews to fix the reading support at a desired angle. At the top of the support 40 are two reading material clamps 44, e.g., one for each side of a book or magazine. At the bottom of the reading material support is an optional ledge 41, which may be a simple ledge or may have a more complex shape, e.g., including a page retaining lip generally parallel to the main surface of the support. FIG. 5 shows a reading material support 46 either retained in, attached to the rear clamp face of, or integral with, the rear claim face of clamp 48. The clamp may be fixed position, or may be angle adjustable. At the lower edge of the support 46 is an optional ledge 47, which may have a lip generally as described for the embodiment of FIG. 4. Optional page retaining bars 50 (e.g., spring wires) are also shown. Such bars may be incorporated in essentially any of the present stands, including in ones which have a reading material support surface. Yet another optional feature which may be included in essentially any of the stands is a light, e.g., as illustrated as light 60. In the example shown, the light includes flexible mounting 61 and light head 62. Any of a variety of different types of lights may be used, e.g., incandescent, halogen, or light emitting diode (LED), which may be mounted using any of a large variety of different mounts.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the dimensions of the reading stand components and to the materials utilized. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A reading stand comprising
a stabilized upright stand column;
a laterally extending arm attached to said column; and
a reading material clamp mounted substantially distally on said arm, wherein said reading material clamp is oriented such that reading material clamped in said clamp extends below said clamp with said reading material below said arm.

2. The reading stand of claim 1, wherein said column is mounted in a weighted base.

3. The reading stand of claim 1, wherein said column is mounted in a wheeled base.

4. The reading stand of claim 1, wherein said arm is pivotably attached to said stand column such that the height of the distal end of said arm can be adjusted.

5. The reading stand of claim 1, wherein the height of said stand column is adjustable.

6. The reading stand of claim 1, further comprising a reading material support surface.

7. The reading stand of claim 6, wherein said reading material support surface is retained in said clamp.

8. The reading stand of claim 6, wherein said clamp is attached to said reading material support surface.

9. (canceled)

10. The reading stand of claim 1, wherein the length of said laterally extending arm is adjustable.

11. The reading stand of claim 1, further comprising a reading light.

12. The reading stand of claim 1, wherein the inclination of reading material clamped in said clamp is adjustable.
